(19) United States
(12) Patent Application Publication
(10) Pub. No.: US 2024/0399511 A1
(43) Pub. Date: Dec. 5, 2024

(54) SPATTER DETECTION METHOD

(71) Applicant: TOYOTA JIDOSHA KABUSHIKI KAISHA, Toyota-shi (JP)

(72) Inventors: Nao KAWABE, Chiba-shi (JP); Tomohiko SEKIGUCHI, Nagakute-shi (JP); Toru HIOKI, Nisshin-shi (JP); Tomoko OGASAHARA, Nagoya-shi (JP); Shota EJIMA, Nagoya-shi (JP); Yosuke TAMADA, Toyota-shi (JP); Takaya OBARA, Toyota-shi (JP)

(73) Assignee: TOYOTA JIDOSHA KABUSHIKI KAISHA, Toyota-shi (JP)

(21) Appl. No.: 18/664,994

(22) Filed: May 15, 2024

(30) Foreign Application Priority Data
Jun. 5, 2023 (JP) 2023-092709

(51) Int. Cl. B23K 31/12; B23K 11/11; B23K 11/25

(52) U.S. Cl. CPC B23K 31/125; B23K 11/115; B23K 11/253; B23K 11/255

(57) ABSTRACT

A spatter detection method for accurately determining whether or not spatter has been generated when resistance spot welding is performed is provided. A spatter detection method including: a welding step for welding a plurality of welding materials by sandwiching parts to be welded of the welding materials between a pair of electrodes and then pressurizing the parts to be welded while simultaneously energizing the pair of electrodes; a calculation step for calculating an amount of expansion of the parts to be welded based on a pressurizing force and a stroke between the pair of electrodes; and a determination step for determining that the spatter has been generated when a magnitude of an inclination of an expansion amount waveform falls below a determination threshold, in which in the determination step, determination thresholds different from each other are applied to respective sections obtained by dividing a target period of the determination.

### CROSS REFERENCE TO RELATED APPLICATIONS

This application is based upon and claims the benefit of priority from Japanese patent application No. 2023-092709, filed on Jun. 5, 2023, the disclosure of which is incorporated herein in its entirety by reference.

### BACKGROUND

The present disclosure relates to a spatter detection method, and in particular, to a spatter detection method for detecting spatter generated when a plurality of stacked plate-like welding materials are subjected to resistance spot welding.

In the resistance spot welding, resistance welding is performed by sandwiching parts to be welded of the plurality of stacked plate-like welding materials between a pair of electrodes and then pressurizing them while simultaneously energizing the pair of electrodes. When the heat generated by the resistance welding becomes excessive, spatter may be generated due to scattering of a part of the parts to be welded. When spatter is generated, there is a possibility that welding failure occurs in and near the parts to be welded.

Therefore, Japanese Unexamined Patent Application Publication No. 2008-105041 discloses a method for, in resistance spot welding, detecting generation of spatter by detecting the change of the amount of electrode displacement, voltage between electrodes, or resistance between electrodes.

Japanese Unexamined Patent Application Publication No. 2008-105041 discloses a resistance welding method for feeding a welding current to a contact part of a joined members and performing resistance heating thereon, in which when generation of spatter is detected during energization, a current (Iw+Iα) obtained by adding a predetermined amount of current Iα to a preset welding current Iw is reset as the welding current, and the current (Iw+Iα) is fed to a member to be welded until a preset energization time T expires.

### SUMMARY

As a method for detecting generation of spatter, determining that spatter has been generated when, for example, a change in a characteristic, such as the amount of electrode displacement, voltage between electrodes, or resistance between electrodes, falls below (or exceeds) a determination threshold (a predetermined value) may be used. However, the change in a characteristic caused by the generation of spatter may be superimposed on a change in a characteristic caused by a factor different from the generation of spatter. In this case, when a single determination threshold is used to determine whether or not spatter has been generated, there is a problem that it may be erroneously determined whether or not spatter has been generated due to a large amount of change.

The present disclosure has been made in order to solve the above-described problem and an object of the present disclosure is to provide a spatter detection method for accurately determining whether or not spatter has been generated when resistance spot welding is performed.

A spatter detection method according to an embodiment is a spatter detection method for detecting spatter generated when a plurality of stacked plate-like welding materials are subjected to resistance spot welding, the spatter detection method including: a welding step for welding the plurality of plate-like welding materials by sandwiching parts to be welded of the welding materials between a pair of electrodes and then pressurizing the parts to be welded while simultaneously energizing the pair of electrodes; a calculation step for calculating an amount of expansion of the parts to be welded based on a pressurizing force and a stroke between the pair of electrodes; and a determination step for determining that the spatter has been generated when a magnitude of an inclination of an expansion amount waveform indicating a temporal shift in the amount of expansion falls below a preset determination threshold, in which in the determination step, determination thresholds different from each other are applied to respective sections obtained by dividing a target period of the determination into at least two sections, and each of the determination thresholds corresponding to a respective one of the sections is compared to the magnitude of the inclination of the expansion amount waveform.

According to the present disclosure, it is possible to provide a spatter detection method for accurately determining whether or not spatter has been generated when resistance spot welding is performed.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic diagram of a resistance spot welding system;

FIG. 2 is a diagram showing a temporal shift in the amount of expansion and a temporal shift in an inclination of an expansion amount waveform;

FIG. 3 is a diagram showing a temporal shift in the amount of expansion and a temporal shift in an inclination of an expansion amount waveform for explaining a spatter detection method according to an embodiment;

FIG. 4 is a diagram showing a temporal shift in the amount of expansion and a temporal shift in an inclination of an expansion amount waveform for explaining a spatter detection method according to a comparative example 1; and

FIG. 5 is a diagram showing a temporal shift in the amount of expansion and a temporal shift in an inclination of an expansion amount waveform for explaining a spatter detection method according to a comparative example 2.

### DESCRIPTION OF EMBODIMENTS

### First Embodiment

An embodiment according to the present disclosure will be described hereinafter with reference to the drawings. However, the present disclosure is not limited to the following embodiment. Further, for the clarification of the description, the following descriptions and the drawings are simplified as appropriate. In the following description, the same or equivalent components will be denoted by the same reference symbols, and redundant descriptions will be omitted.

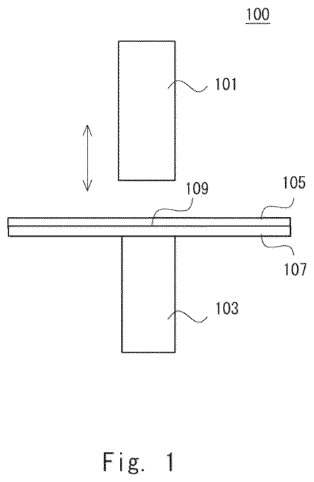

FIG. 1 is a schematic diagram of a resistance spot welding system. A resistance spot welding system 100 will be described with reference to FIG. 1. The resistance spot welding system 100 shown in FIG. 1 includes a pair of electrodes, which are upper movable electrode 101 and a lower fixed electrode 103. A part 109 to be welded of a metal plate 105 and a part 109 to be welded of a metal plate 107 are arranged in a stacked manner between the upper movable electrode 101 and the lower fixed electrode 103. Note that the movable electrode and the fixed electrode may be upside down. The metal plate 105 and the metal plate 107 are a plurality of plate-like welding materials, which are stacked vertically.

The upper movable electrode 101 moves vertically as indicated by an arrow, thereby pressurizing the parts 109 to be welded. The upper movable electrode 101 and the lower fixed electrode 103 sandwich the parts 109 to be welded from a direction in which the metal plate 105 and the metal plate 107 are stacked. The upper movable electrode 101 and the lower fixed electrode 103 feed current while pressurizing the parts 109 to be welded. The metal plate 105 and the metal plate 107 are welded by resistance heat generated in the parts 109 to be welded sandwiched between the upper movable electrode 101 and the lower fixed electrode 103. The parts 109 to be welded are fused by the resistance heat and then solidified to form a nugget. In FIG. 1, it is shown that the number of metal plates is two, but the number of metal plates may be three or more.

The amount by which the upper movable electrode 101 comes into contact with the metal plate 105 and then is pushed toward it is referred to as a stroke. The stroke is measured by the upper movable electrode 101. A pressurizing force is measured by the lower fixed electrode 103. A computer or other processing apparatus (not shown) uses these measured values to calculate the amount of expansion of the parts 109 to be welded. Then the processing apparatus generates an expansion amount waveform showing a temporal shift in the amount of expansion based on the calculated amount of expansion.

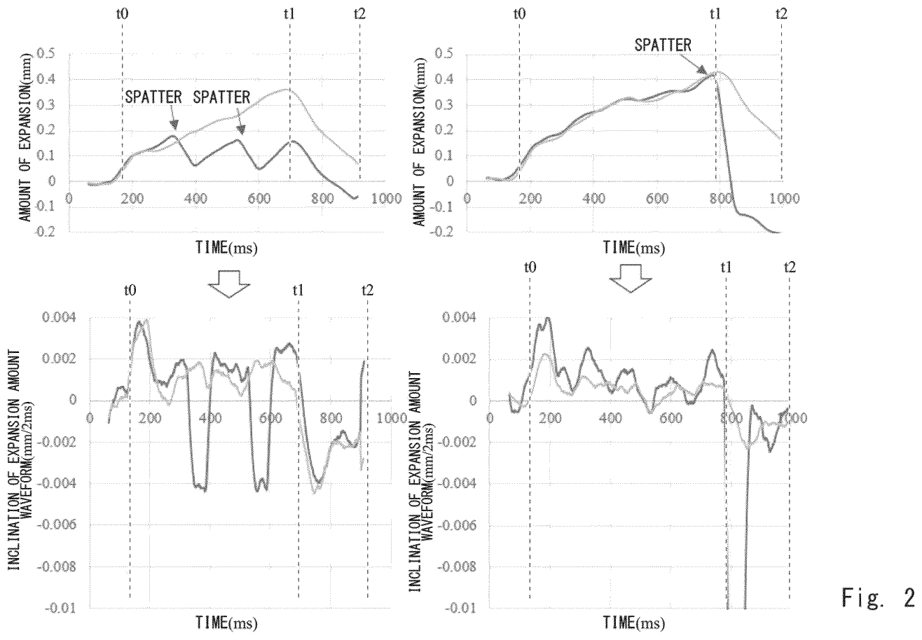

FIG. 2 is a diagram showing a temporal shift in the amount of expansion and a temporal shift in an inclination of an expansion amount waveform. Graphs at the left side of FIG. 2 respectively show a temporal shift in the amount of expansion and a temporal shift in an inclination of an expansion amount waveform for each of a case in which spatter has been generated in the first half of an energization time and a case in which spatter has not generated in the first half of an energization time. Graphs at the right side of FIG. 2 respectively show a temporal shift in the amount of expansion and a temporal shift in an inclination of an expansion amount waveform for each of a case in which spatter has been generated near the end of an energizing time and a case in which spatter has not generated near the end of an energizing time. The trends of the amount of expansion and an expansion amount waveform for each of a case in which spatter has been generated and a case in which spatter has not generated will be described with reference to FIG. 2.

In each graph of FIG. 2, a temporal shift in the amount of expansion and a temporal shift in an inclination of an expansion amount waveform in a case in which spatter has been generated are shown as solid black lines. In each graph in FIG. 2, a temporal shift in the amount of expansion and a temporal shift in an inclination of an expansion amount waveform in a case in which spatter has not generated are shown as solid gray lines.

The vertical axis of each graph in the upper part of FIG. 2 shows the amount of expansion of the parts 109 to be welded calculated from the measured value of the stroke and the measured value of the pressurizing force. The amount of expansion of the parts 109 to be welded is determined by the following equation (1).

$$E = S + a \times F \qquad ( 1 )$$

In the equation (1), E is an amount of expansion, S is a stroke, a is a strain amount conversion coefficient, and F is a pressurizing force. The strain amount conversion coefficient a is a coefficient that converts the pressurizing force into an amount of strain and can be any constant.

As described above, by using the stroke measured by the upper movable electrode 101 and the pressurizing force measured by the lower fixed electrode 103, the amount of expansion can be calculated with higher accuracy than when either of them is used independently. An inclination of an expansion amount waveform showing a temporal shift in the amount of expansion, is the amount of change in the amount of expansion per unit time.

A time point t0 indicates a start point of the energization time. A time point t1 indicates an end point of the energization time. The time point t1 also indicates a start point of a holding time during which the upper movable electrode 101 and the lower fixed electrode 103 are held until they are opened. A time point t2 indicates an end point of the holding time during which the upper movable electrode 101 and the lower fixed electrode 103 are held until they are opened.

As shown on the left side of FIG. 2, when energization is initiated, spatter may be generated in a section from the time point t0 to the time point t1. The amount of expansion changes rapidly (decreases) when spatter has been generated. Therefore, it is possible to detect spatter from the inclination of the expansion amount waveform. In order to detect spatter, it is possible to determine that spatter has been generated when, for example, the magnitude of the inclination of the expansion amount waveform falls below a preset determination threshold.

As shown on the right side of FIG. 2, the parts 109 to be welded of the welding materials shrink as the energization is ended and hence a change (decrease) in the amount of expansion caused by the shrinkage of the welding materials occurs immediately after the end of the energization time. Therefore, the amount of expansion and the inclination of the expansion amount waveform decrease from around the time point t1 as shown by the solid gray line. Note that, when spatter has been generated near the end of the energization time, the change in the amount of expansion caused by the shrinkage of the welding materials is superimposed on the change in the amount of expansion caused by the generation of spatter. When these two changes in the amount of expansion are superimposed, the amount of expansion and the inclination of the expansion amount waveform rapidly change (decrease) from the time point t1 as shown by the solid black line. Further, the minimum value of the inclination of the expansion amount waveform in the section from the time point t1 to the time point t2 becomes significantly smaller than the minimum value of the inclination of the expansion amount waveform in the section from the time point t0 to the time point t1.

Therefore, when a period of one cycle of the expansion amount waveform including the time point t0 to the time point t2 is set as a target period of the determination, there is a problem that the detection accuracy of spatter is reduced when whether or not spatter has been generated is determined by applying a single determination threshold to the target period. As an example of a case in which the above problem occurs, spatter detection methods according to comparative examples 1 and 2 in which a single determination threshold is applied to the target period will be described concretely.

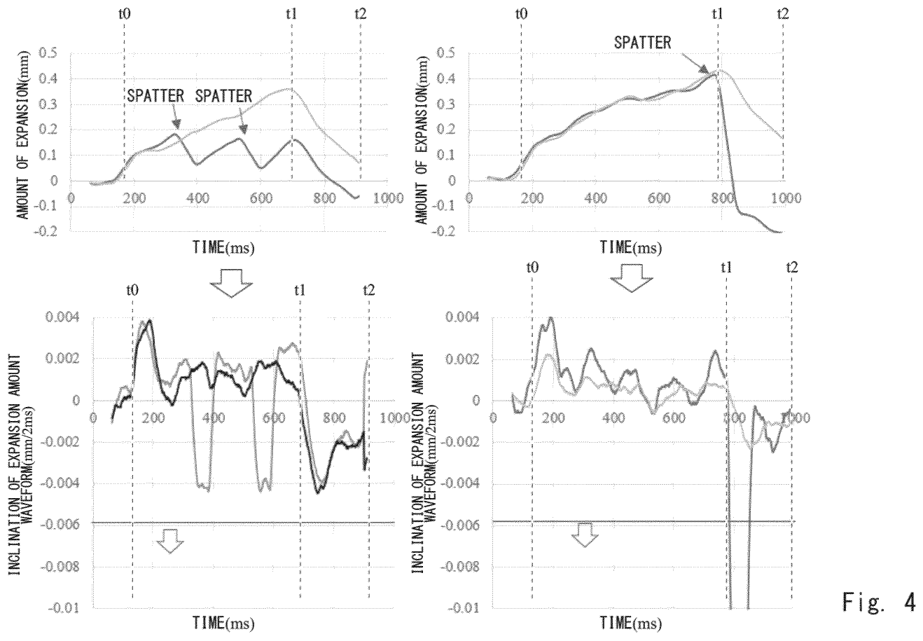

FIG. 4 is a diagram showing a temporal shift in the amount of expansion and a temporal shift in an inclination of an expansion amount waveform for explaining the spatter detection method according to the comparative example 1. In the spatter detection method according to the comparative example 1 shown in FIG. 4, a preset determination threshold of −0.006 mm/ms is applied to the target period. In the spatter detection method according to the comparative example 1, it is possible to determine that spatter has been generated when the magnitude of the inclination of the expansion amount waveform falls below −0.006 mm/ms. Note that −0.006 mm/ms, which is the determination threshold, is a value that is larger by a predetermined ratio from the minimum value of the inclination of the expansion amount waveform when the change in the amount of expansion caused by the generation of spatter is superimposed on the change in the amount of expansion caused by the shrinkage of the welding materials.

As shown by the solid black line on the left side of FIG. 4, when spatter is detected by the spatter detection method according to the comparative example 1, the inclination of the expansion amount waveform showing the change in the amount of expansion caused by spatter that has been generated in the first half of the energization time in the section from the time point t0 to the time point t1 is equal to or greater than the determination threshold. Further, as shown by the solid gray line on the left side of FIG. 4, the inclination of the expansion amount waveform showing the change in the amount of expansion caused by the shrinkage of the welding materials that has occurred in the section from the time point t1 to the time point t2, is also equal to or greater than the determination threshold. Therefore, in the spatter detection method according to the comparative example 1, although the shrinkage of the welding materials that has occurred immediately after the end of the energization time is prevented from being erroneously detected as spatter, there is a problem that spatter that has been generated in the first half of the energization time cannot be detected.

Meanwhile, as shown by the solid black line on the right side of FIG. 4, the change in the amount of expansion caused by spatter that has been generated near the end of the energization time in the section from the time point t0 to the time point t1 is superimposed on the change in the amount of expansion caused by the shrinkage of the welding materials. Thus, when the spatter detection method according to the comparative example 1 is used to detect spatter, the inclination of the expansion amount waveform in which these two changes in the amount of expansion are superimposed in the section from the time point t1 to the time point t2 falls below the determination threshold. Therefore, by the spatter detection method according to the comparative example 1, it is possible to detect spatter that has been generated near the end of the energization time.

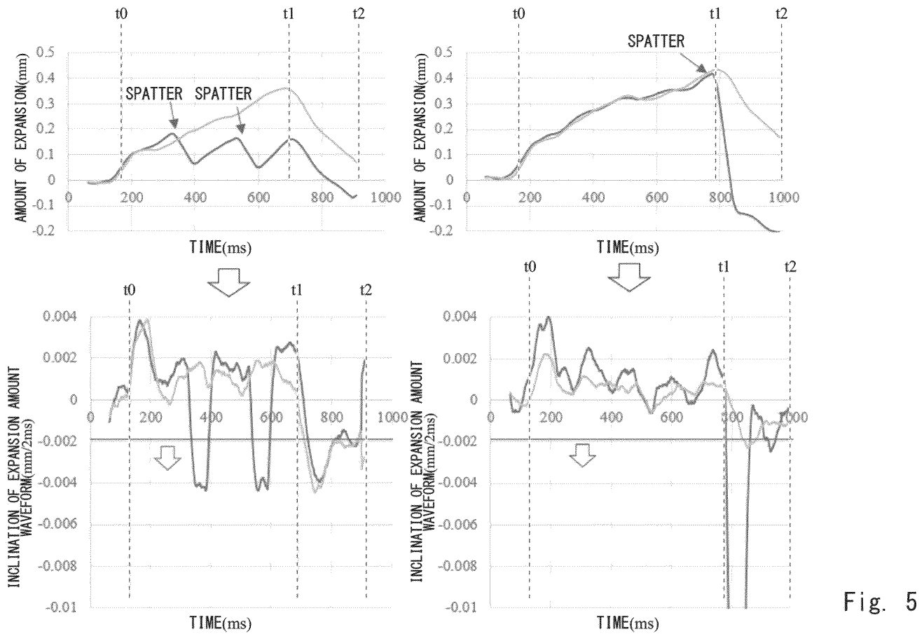

FIG. 5 is a diagram showing a temporal shift in the amount of expansion and a temporal shift in an inclination of an expansion amount waveform for explaining the spatter detection method according to the comparative example 2. In the spatter detection method according to the comparative example 2 shown in FIG. 5, a preset determination threshold of −0.002 mm/ms is applied to the target period. In the spatter detection method according to the comparative example 2, it is possible to determine that spatter has been generated when the inclination of expansion amount waveform falls below −0.002 mm/ms. Note that −0.002 mm/ms, which is the determination threshold, is a value that is larger by a predetermined ratio from the minimum value of the inclination of the expansion amount waveform when a change in the amount of expansion caused by the generation of spatter.

As shown by the solid black line on the left side of FIG. 5, when spatter is detected by the spatter detection method according to the comparative example 2, the inclination of the expansion amount waveform showing the change in the amount of expansion caused by spatter that has been generated in the first half of the energization time in the section from the time point t0 to the time point t1 falls below the determination threshold. Further, as shown by the solid gray line on the left side of FIG. 5, the inclination of the expansion amount waveform showing the change in the amount of expansion caused by the shrinkage of the welding materials that has occurred in the section from the time point t1 to the time point t2 also falls below the determination threshold. Therefore, in the spatter detection method according to the comparative example 2, although the spatter that has been generated in the first half of the energization time can be detected, there is a problem that the shrinkage of the welding materials that has occurred immediately after the end of the energization time is erroneously detected as spatter.

Meanwhile, as shown by the solid black line on the right side of FIG. 5, when the spatter detection method according to the comparative example 2 is used to detect spatter, the inclination of the expansion amount waveform in which the change in the amount of expansion caused by spatter that has been generated near the end of the energization time in the section from the time point t0 to the time point t1 is superimposed on the change in the amount of expansion caused by the shrinkage of the welding materials that has occurred in the section from the time point t1 to the time point t2 also falls below the determination threshold. Therefore, by the spatter detection method according to the comparative example 2, it is possible to detect spatter that has been generated near the end of the energization time.

In contrast, the spatter detection method according to the present embodiment is a spatter detection method for detecting spatter generated when a plurality of stacked plate-like welding materials are subjected to resistance spot welding, and the spatter detection method includes the following welding, calculation, and determination steps.

In the welding step, a plurality of plate-like welding materials are welded by sandwiching the parts 109 to be welded of the welding materials between a pair of electrodes and then pressurizing the parts 109 to be welded while simultaneously energizing the pair of electrodes. In the calculation step, the amount of expansion of the parts 109 to be welded is calculated based on a pressurizing force and a stroke between the pair of electrodes. In the determination step, it is determined that spatter has been generated when the magnitude of the inclination of the expansion amount waveform showing a temporal shift in the amount of expansion falls below a preset determination threshold. Further, in the determination step, a plurality of different determination thresholds are applied for each section in which the target period of the determination is divided into at least two sections, and the determination threshold corresponding to each section is compared to the magnitude of the inclination of the expansion amount waveform.

First, in the welding step, the metal plate 105 and the metal plate 107 are welded by sandwiching the parts 109 to be welded of the metal plate 105 and the metal plate 107 between the upper movable electrode 101 and the lower fixed electrode 103 of the above resistance spot welding system 100, and then energizing the upper movable electrode 101 and the lower fixed electrode 103. In the welding step, when the energizing is started, the parts 109 to be welded of the welding materials sandwiched between the upper movable electrode 101 and the lower fixed electrode 103 expand. Then, after the energizing is finished, the parts 109 to be welded of the welding materials shrink while the upper movable electrode 101 and the lower fixed electrode 103 are held until they are opened. In the welding step, as the parts 109 to be welded solidify, a nugget is formed between the metal plate 105 and the metal plate 107, and the metal plate 105 and the metal plate 107 are welded.

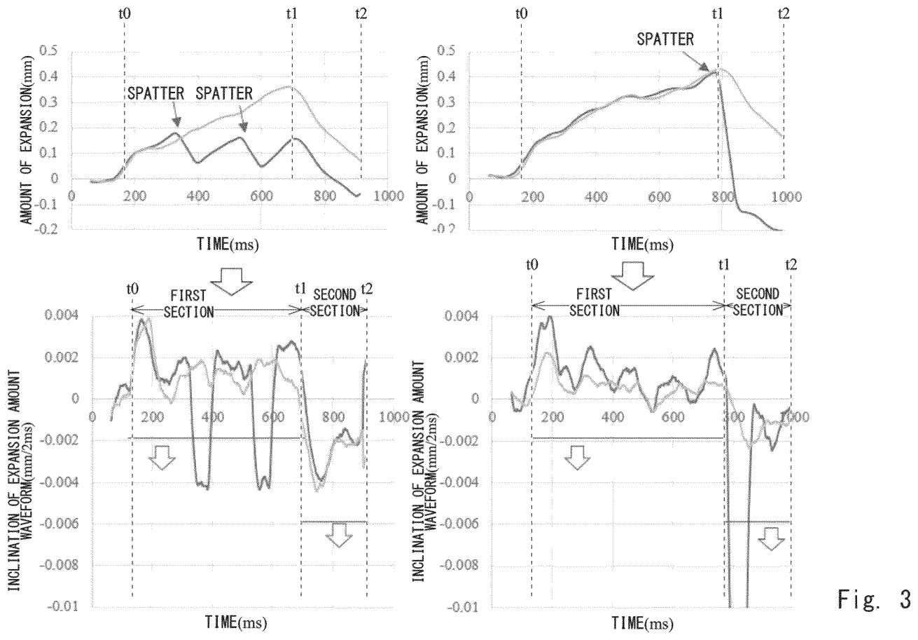

Next, in the calculation step, an expansion amount waveform indicating a temporal shift of the amount of expansion of the parts 109 to be welded is calculated from the measured value of the stroke and the measured value of the pressurizing force. The amount of the expansion of the parts 109 to be welded may be determined by the above equation (1) using the stroke measured by the upper movable electrode 101 and the pressurizing force measured by the lower fixed electrode 103. FIG. 3 is a diagram showing a temporal shift in the amount of expansion and a temporal shift in an inclination of an expansion amount waveform for explaining a spatter detection method according to the embodiment.

The determination step will be described concretely with reference to FIG. 3. As shown in FIG. 3, in the determination step, the target period may be divided into two sections: a first section from the start point of the energization time to the end thereof, and a second section from the end point of the energization time to the end point of the holding time during which the upper movable electrode 101 and the lower fixed electrode 103 are held until they are opened. That is, the target period is a period from the time point t0 to the time point t2. Further, the first section may be a section from the time point t0 to the time point t1, and the second section may be a section from the time point t1 to the time point t2. By doing so, not only spatter generated in the first half of the energization time but also spatter generated near the end of the energization time can be detected with high accuracy.

Further, in the determination step, a first determination threshold and a second determination threshold, which are different from each other, are applied to the first section and the second section as determination thresholds. Specifically, in the determination step, the first determination threshold is applied to the first section, and the second determination threshold, which is smaller than the first determination threshold, is applied to the second section. In the example shown in FIG. 3, the first determination threshold is −0.002 mm/ms, and the second determination threshold is −0.006 mm/ms.

In the determination step, when the magnitude of the inclination of the expansion amount waveform falls below −0.002 mm/ms in the first section, it is determined that spatter has been generated. Note that −0.002 mm/ms, which is the first determination threshold, is, for example, a value that is larger by a predetermined ratio from the minimum value of the inclination of the expansion amount waveform when a change in the amount of expansion caused by the generation of spatter.

Further, in the determination step, when the magnitude of the inclination of expansion amount waveform falls below −0.006 mm/ms in the second section, it is determined that spatter has been generated. Note that −0.006 mm/ms, which is the second determination threshold, is, for example, a value that is larger by a predetermined ratio from the minimum value of the inclination of the expansion amount waveform when the change in the amount of expansion caused by the generation of spatter is superimposed on the change in the amount of expansion caused by the shrinkage of the welding materials.

As shown by the solid black line on the left side of FIG. 3, when spatter is detected by the spatter detection method according to the present embodiment, the inclination of the expansion amount waveform showing the change in the amount of expansion caused by the spatter that has been generated in the first half of the energization time in the first section falls below the first determination threshold. Meanwhile, as shown by the solid gray line on the left side of FIG. 3, the inclination of the expansion amount waveform showing the change in the amount of expansion caused by the shrinkage of the welding materials that has occurred in the second section is equal to or greater than the second determination threshold. Therefore, by the spatter detection method according to the present embodiment, the shrinkage of the welding materials that has occurred immediately after the end of the energization time can be prevented from being erroneously detected as spatter, and spatter that has been generated in the first half of the energization time can be detected.

Further, as shown by the solid black line on the right side of FIG. 3, when spatter is detected by the spatter detection method according to the present embodiment, the inclination of the expansion amount waveform in which the change in the amount of expansion caused by spatter that has been generated near the end of the energization time in the first section is superimposed on the change in the amount of expansion caused by the shrinkage of the welding materials that has occurred in the second section falls below the second determination threshold. Therefore, by the spatter detection method according to the present embodiment, spatter that has been generated near the end of the energization time can also be detected.

As described above, in the spatter detection method according to the present embodiment, it is determined whether or not spatter has been generated based on a comparison between each of a plurality of determination thresholds set to different values according to the timings of the generation of spatter and the inclination of the expansion amount waveform. Therefore, by the spatter detection method according to the present embodiment, it is possible to accurately determine whether or not spatter has been generated when resistance spot welding is performed.

Note that the present disclosure is not limited to the above-described embodiment and may be changed as appropriate without departing from the scope and spirit of the present disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A spatter detection method for detecting spatter generated when a plurality of stacked plate-like welding materials are subjected to resistance spot welding, the spatter detection method comprising:
a welding step for welding the plurality of plate-like welding materials by sandwiching parts to be welded of the welding materials between a pair of electrodes and then pressurizing the parts to be welded while simultaneously energizing the pair of electrodes;
a calculation step for calculating an amount of expansion of the parts to be welded based on a pressurizing force and a stroke between the pair of electrodes; and
a determination step for determining that the spatter has been generated when a magnitude of an inclination of an expansion amount waveform indicating a temporal shift in the amount of expansion falls below a preset determination threshold,
wherein in the determination step, determination thresholds different from each other are applied to respective sections obtained by dividing a target period of the determination into at least two sections, and each of the determination thresholds corresponding to a respective one of the sections is compared to the magnitude of the inclination of the expansion amount waveform.

2. The spatter detection method according to claim 1, wherein
in the determination step,
the target period is divided into two sections: a first section from a start point of an energization time to an end point thereof and a second section from the end point of the energization time to an end point of a holding time during which the pair of electrodes are held until they are opened, and
a determination threshold that is smaller than the determination threshold applied to the first section is applied to the second section.

3. The spatter detection method according to claim 1, wherein the amount of expansion is calculated by the following equation:
$$E = S + a \times F \qquad ( 1 )$$
wherein E is an amount of expansion, S is a stroke, a is a strain amount conversion coefficient, and F is a pressurizing force.
